(19) United States
(12) Patent Application Publication
(10) Pub. No.: US 2026/0317928 A1
(43) Pub. Date: Oct. 15, 2026

(54) Cell with Anisotropic Sealing Gaskets

(71) Applicant: Viering, Jentschura & Partner mbB, München (DE)

(72) Inventors: Daniele Nuzzo, Milan (IT); Silvia D'Amato, Milan (IT); Michele Perego, Milan (IT); Mirko Liuzzo, Milan (IT)

(21) Appl. No.: 19/486,099

(22) PCT Filed: May 6, 2024
(86) PCT No.: PCT/EP2024/062413

§ 371 Date: Nov. 20, 2025

(30) Foreign Application Priority Data
Jun. 26, 2023 (IT) 102023000013113

(51) Int. Cl. C25B 13/08; C25B 1/04

(52) U.S. Cl. CPC C25B 13/08; C25B 1/04

(57) ABSTRACT

The present invention relates to a divided cell for alkaline water electrolysis, where the separator is equipped with a gasket having anisotropic elastic properties and exhibiting reduced gasket deformation along the plane of the major surface of the separator when subject to a compression force perpendicular to that plane. The invention also relates to an electrolyser comprising a plurality of cells as hereinbefore described.

### FIELD OF THE INVENTION

The present invention concerns a new gasketing solution for divided cells for alkaline water electrolysis to avoid separator damage during gasket compression.

### BACKGROUND OF THE INVENTION

In alkaline water electrolysis (AWE), electrolysers usually comprise a plurality of divided electrolytic cells in hydraulic and electric connection with each other. Each cell is typically composed of an anodic compartment comprising an anode, and a cathodic compartment comprising a cathode, immersed in a current conductive liquid media, respectively the anolyte and the catholyte. The two cell compartments are divided by a separator, such as a diaphragm or a membrane.

Typically, each individual cell of the electrolyser comprises, on the anodic side, (i) a first current distributor, such as a bipolar plate or a powering component suitable to either carry electric current from cell to cell or to power a single cell, and to prevent leakage of reactants and coolants, (ii) an optional current collector, to uniformly distribute the current on the electrode surface, (iii) an optional elastic element, and (iv) an anode. Analogously, the cathodic side typically comprises (i) a cathode, (ii) an elastic element (optional), (iii) a current collector (optional), and (iv) a second current distributor closing the cell, with the separator being placed in between the two sides, and specifically between the two opposite electrodes.

In the above scenario, all functional elements, where present, are typically placed in sequence along the longitudinal axis of the cell, and oriented substantially parallel to its transverse plane, which is the plane perpendicular to said longitudinal axis. The elements are also placed in electrical contact with each other, either because of their direct spatial contiguity (zero-gap configuration) or through the aid of additional conductive elements or via a conductive medium: the electrolyte.

In case of an electrolyser comprising a plurality of cells sequentially placed in series with each other, one same current distributor may be shared among two adjacent cells, for example by using a bipolar plate in contact, on one side, with the anode of a first cell and, on the other side, with the cathode of a second adjacent cell.

Usually, each compartment is equipped with one cell frame designed to house one or more of the elements recited above, namely the anode and/or the cathode. Usually, the frame of the anodic and cathodic compartments are in contact with the separator, pressed against its opposite sides in the direction of the longitudinal axis of the cell.

The separator allows to separate hydrogen, generated at the cathode, from oxygen, generated at the anode, while allowing the transfer of OH- ions from the cathodic compartment to the anodic compartment. While there will always be a certain amount of free oxygen and free hydrogen present in both compartments, it is important for the separator to ensure a low concentration of oxygen into hydrogen at the cathodic compartment, and of hydrogen into oxygen at the anodic compartment, for both safety and economic reasons.

State-of-the-art separators are often made of low thickness plastic fibers (such as PPS) in fabric form. They may be coated with compositions that increase OH- transfer while limiting the electrolyte and gasses flow through the separator. The overall thickness of these state-of-the-art separators ranges from 50 μm to 1000 μm and is usually limited between 150 μm and 600 μm.

These state-of-the-art separators should be sealed in order to limit gas crossflow from one compartment of the cell to the other. A typical and acceptable crossflow reduction is in the order of about 40%-80%.

The sealing of state-of-the-art separators is obtained by installing gaskets on the periphery of the separator, between the separator and the cell frame.

The efficacy of the sealing depends on the compression force applied to the gaskets, which determines the maximum pressure the gasket can hold. A higher compression force results in a higher maximum allowable pressure. Usually, this force is applied along the same direction of the longitudinal axis of the cell since the major surface of the separator is placed substantially parallel to the transverse plane.

State-of-the-art separator gaskets are made of rubber or polymeric materials chemically compatible with strong alkalis and free hydrogen/oxygen, such as Ethylene-Propylene Diene Monomer (EPDM), chlorosulfonated polyethylene (CSPE), perfluoroelastomeric compounds (FFKMs), and Polytetrafluoroethylene (PTFE). When these gaskets are subject to a compression force, the material displaces in two directions: it decreases its thickness along the same direction of the compression force (i.e. the longitudinal axis of the cell) while extending in the plane perpendicular to the compression force, i.e. the transverse plane. In other words, the gasket flattens under the pressure exerted upon it, changing its shape without appreciably altering its volume during and after compression. Since the separator is in contact with the gasket, it is subject to two forces: (a) a compression force equal to the compression force applied to the gasket in the longitudinal direction; (b) a drag/pulling force in the transverse plane, which we shall refer to as traction resistance, resulting from the expansion of the gasket under compression in the transverse plane.

When the separator is installed in a pressurized electrolysis cell, the compression force applied to the gaskets can be very high, resulting in high gasket compression stress (>10 MPa). This further results in an increase of forces (a) and (b) described above.

Current separators are characterized by a compression resistance much higher than their traction resistance, because of their inherent anisotropy. Because of this, force (a) does not damage the separator in any way. On the other hand, force (b) results in a dangerous tensile stress that can easily damage and even break the separator in the area near to the gasket.

It is therefore desirable to solve the issue of separator damage related to the dragging force generated by gasket displacement in the transverse plane.

### DETAILED DESCRIPTION

Under one aspect the present invention relates to a divided cell suitable for alkaline water electrolysis comprising an anodic compartment, a cathodic compartment, and a separator placed in between the anodic compartment and the cathodic compartment along a longitudinal direction. Each of the two major opposite surfaces of the separator is provided with at least one anisotropic sealing gasket to limit gas crossflow from one compartment of the cell to the other.

The anisotropic sealing gaskets shall be made of an anisotropic material having an anisotropic elastic response when subject to a compression force. To this effect, the anisotropic sealing gaskets must have an adequate Poisson coefficient v when evaluated in the longitudinal direction (z) and in a transversal direction, i.e. a direction within the transverse plane (xy) perpendicular to (z).

In general, the Poisson coefficient v is defined as the negative of the ratio between the strain Eₜᵣₐₙₛ in a transversal direction and the strain E_{long} in the longitudinal direction when the material is subject to a longitudinal stress. In first approximation this gives v=Eₜᵣₐₙₛ/E_{long}. The strain Eₜᵣₐₙₛ may vary within the plane (xy).

The desired modulus |v| of the Poisson coefficient v of the anisotropic gasket is such that there is at least one direction in the transverse plane, i.e. a transverse direction, where |v|=0-0.3, preferably |v|=0-0.2, and even more preferably |v|=0-0.1. Preferably the above values apply in all directions of the transverse plane.

In a preferred embodiment the above values apply at least in the direction of the width of the anisotropic sealing gaskets, as measured along any point along the length of the gasket, and assuming that each gasket has a certain thickness t_{z}, width w and length l, with l>w. It is noted that both l and w lie in the transverse plane, but their orientation within that plane changes depending on the gasket geometric profile (for example oval, circular, rectangular, square), which in turns depends on the cell geometry.

The anisotropic properties of the gasket in connection with its elastic properties allows to protect the separator from tear and damages, since the Poisson coefficient ensures that the gasket will not displace uniformly in all directions, i.e. will not maintain a substantially constant volume under the exertion of a force.

Indeed, contrary to conventional gaskets where any compression along a given direction is compensated by a comparable expansion along a perpendicular direction, thereby keeping its volume roughly constant, the anisotropic gasket according to the invention exhibits different displacements depending on the direction along which it expands/compresses. If suitably placed, when the anisotropic gasket of the invention is subject to a compression force along the longitudinal axis of the cell, its thickness along that direction is lowered, as is the case for traditional separator gaskets, and the compression force is transferred to the separator. However, the displacement in the transverse plane of the cell is much lower than that of traditional gaskets, thanks to its anisotropic elastic properties defined by the chosen |v| and a suitable orientation of the material. The resulting dragging force due to the displacement of the gasket along the major surface of the separator due to its flattening under the compression force is greatly reduced with respect to conventional gaskets, thereby reducing the risk of damaging the separator.

The integrity of the separator, which may be a diaphragm or a membrane, is paramount during operation of a divided AWE cell: in case it is damaged, the flow of hydrogen from the cathodic side to the anodic side and/or the flow of oxygen from the anodic side to the cathodic side would drastically increase. This event could rapidly increase the HTO (Hydrogen to Oxygen) and/or the OTH (Oxygen to Hydrogen) levels of the gas mixtures above the safety limits required for explosive gas mixtures.

In general, gaskets with an anisotropic response to mechanical stress can be obtained by selecting appropriate commercially available materials. These are sourced by selecting specific compositions which naturally exhibit the desired properties and/or via suitably designed manufacturing techniques such as material expansion with gasses or by the specific formation steps of composite materials.

Examples of anisotropic sealing gasket materials that have been observed to work well in the execution of the invention, are: expanded elastomers and expanded fluoropolymers, and more specifically ePTFE, expanded EPDM or expanded chlorosulfonated polyethylene.

For instance, ePTFE is extremely anisotropic and, when subjected to compressive forces in the longitudinal direction, there is little deformation in the perpendicular transverse plane. Thus, its use for gaskets in the context of the present invention is particularly advantageous as it avoids stress to the separator. For instance ePTFE may be manufactured to produce gaskets with a value |v|=Δ//Δt_{z} of 0.177 measured along the direction of the length of the gasket, and a value |v|=Δw/Δt_{z} of 0.073 along the direction of the gasket width. These characterizing measurements were taken by the inventors along multiple areas of a sample ePTFE gasket along its longitudinal direction and subsequently averaged. The sample gasket was 10×20×3 mm (w·l·t_{z}) and it was subject to a pressure of 50 MPa. The elongation Δw, Δl, Δt_{z} of the gasket width, length and thickness under pressure was measured with a tensile testing machine.

It is understood that as materials science progresses, new and equally suitable materials may be used to achieve the same or similar effect. In any event it is advisable to select materials that are chemically compatible with the electrolyte, and suitable to work at the operating temperatures of the cell where they are installed. As a non-limiting example, typical state-of-the-art AWE cells operate at temperatures of 60 °C to 110 °C and use strong aqueous alkali solutions, such as KOH or NaOH solutions, as electrolytes.

The present invention is particularly advantageous when the separator is 50 μm to 500 μm thick and therefore delicate and subject to wear and tear if conventional gaskets are used. The separators may be made of any suitable materials, such as fabrics of plastic fibers, optionally coated to favor OH- transport (for instance they may be coated with zirconium-based compositions).

The inventors have observed that a separator made of a commercially available open mesh PPS fabric, symmetrically coated with a mixture of a polymer and zirconium oxide, works particularly well in the execution of the invention.

Under another embodiment, the cell according to the invention is arranged according to the following. The anodic compartment comprises an anode housed in a supporting frame and other optional elements, such as a current collector and/or an elastic element. The cathodic compartment comprises a cathode housed in a supporting frame, and optionally an elastic element and/or a current collector. The anode and the cathode are divided by a separator placed between them, the separator being equipped with at least one anisotropic gasket as hereinbefore described placed on the anodic side and at least one placed on the cathodic side.

The anodic and cathodic compartments are in electrical connection with a first and a second current distributor, to which the anode and the cathode are respectively connected, either by direct contact or through the coupling of other elements (such as current distributors and/or elastic elements).

The cell thus described may optionally be in zero-gap configuration, with all the elements pressed against each other in mutual physical contact, or gaps of conductive media may be present between some of the functional elements.

Under a second aspect, the present invention relates to an electrolyser for alkaline water electrolysis comprising a plurality of any of the cells hereinbefore described stacked along the longitudinal direction and in mutual electrical and hydraulic connection with each other.

In one embodiment, the cells may be connected in series. In this case the first and last current distributor of the stack provide the electrolyser with the required voltage difference, or current density, for its operation. In an advantageously compact embodiment, the other current distributors of the stack may be chosen as bipolar plates, with adjacent cells sharing one bipolar plate, suitably positioned between them. The bipolar plate in this instance may substitute two separate sequential current distributors, with one side of the bipolar plate being in connection with the anode of a first cell, and the other side of the bipolar plate being in connection with the cathode of a second cell adjacent to the first one.

In alternative, even if less likely, the cells of the electrolyser may be connected in parallel.

In this instance each current distributor powers one compartment of an individual cell.

A plurality of electrolysers can be further mutually connected in series or in parallel.

A few embodiments of the invention are described by way of example below with reference to the appended drawings, the purpose of which is solely to illustrate the mutual arrangement of the various elements relating to said embodiments of the invention. The drawings are not to scale. Identical numbers are used to indicate features having the same purpose/effect. The coordinate axis x, y, z, are used in the same fashion throughout all figures. The xy plane is substantially parallel to the major surface of the separators and the other main functional elements of the cell (electrodes, frames, bipolar plates), whereas z is perpendicular to such plane and identifies the main longitudinal axis of the electrolyser according to the invention.

### DESCRIPTION OF THE DRAWINGS

FIG. 1 provides a schematic view of a separator (500) for a cell according to the invention equipped with anisotropic sealing gaskets (100, 150) having a rectangular profile and placed on each of the two major opposite surfaces of the separator. FIG. 1.a) and FIG. 1.c) shows projections of said opposite surfaces on the transverse plane xy of the cell. FIG. 1.b) shows a view of the separator (500) along the longitudinal direction z of the cell. Because of the rectangular geometry of the sealing gaskets (100, 150), i.e. their profile as projected on the xy plane, the width and length of the gaskets change direction depending on the chosen position along the length of the gasket profile, while remaining perpendicular to each other.

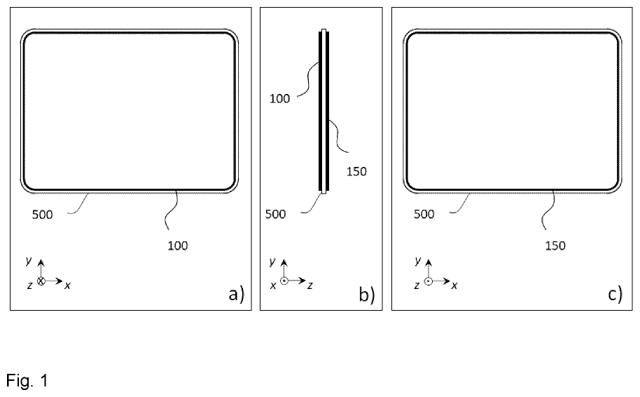

FIG. 2 provides a schematic, exploded view a divided cell according to an embodiment of the invention. The figure shows a plurality of functional elements which are intended to be stacked one after the other along the longitudinal direction z. The major surfaces of these elements lie parallel to the transverse plane xy, perpendicular to z. The cell comprises an anodic compartment, a cathodic compartment, a separator (500) provided with anisotropic gaskets (100) and (150), as well as two current distributors (400) and (450). The anodic compartment comprises a frame (200) suitable to house the bipolar element (400), which has a current collector and an anode welded on its surface, with the anode facing the separator (500). The cathodic compartment of the cell comprises a frame (210), suitable to house the cathode (600) and an elastic element (300). The cathode faces the current distributor (450). On assembly, the separator (500) is sandwiched between the anode surface welded on the current distributor (400) and the cathode (600), thus dividing the anodic and cathodic compartments of the cell from each other. When the electrolyser is assembled, the gaskets protect the separator (500) from dragging/pulling forces in the transverse plane xy, thereby minimizing its wear and tear.

FIG. 3 provides a schematic, exploded view of an internal section of an electrolyser according to an embodiment of the invention, by partially depicting two consecutive cells.

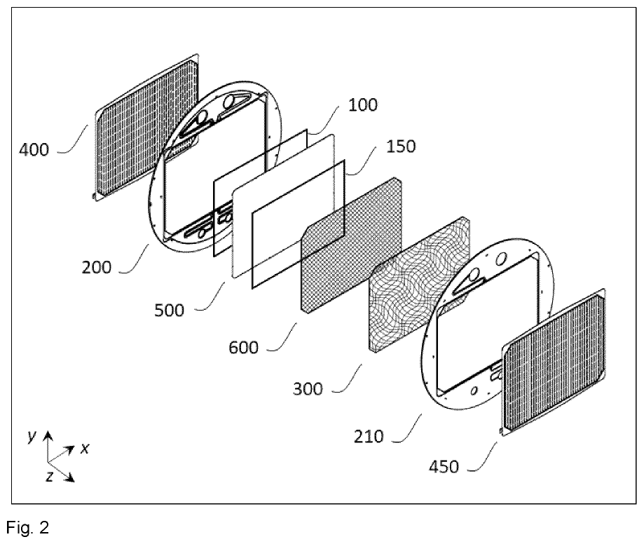

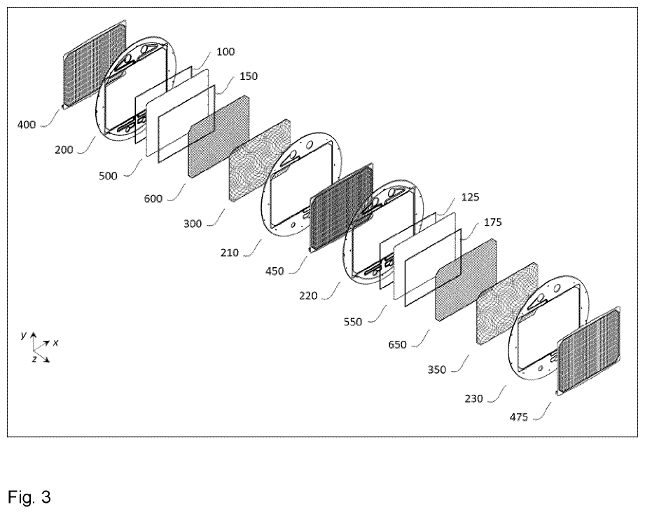

On assembly, the elements are meant to be stacked one after the other along the longitudinal direction z, as described in FIG. 2. The section shows a frame (200) suitable to house a bipolar plate (400) having a current collector and an anode welded on its surface, with the anode facing the separator (500). The separator is provided with anisotropic gaskets (100) and (150). A second frame (210) is suitable to house the cathode (600) and an elastic element (300). The bipolar plate (450), which faces the cathode (600) on one side and is housed in frame (220), closes the first cell hereinbefore described. The bipolar plate (450) also belongs to a second cell. On the side opposite to the cathode (600), it is provided with a current collector welded on its surface and an anode facing the separator (550) belonging to a second neighboring cell. FIG. 3 also shows a frame (230) suitable to house the cathode (650) and the elastic element (350) of the cathodic compartment of the second cell. On assembly, the separator (550), which is provided with anisotropic gaskets (125) and (175), is sandwiched between the anode surface welded on the bipolar element (450) and the cathode (650). The bipolar element facing cathode (650) is not shown. In the present embodiment, the bipolar plate (450) is shared among two consecutive and neighboring cells along the longitudinal direction. When the electrolyser is assembled, the gaskets protect the separators (500, 550) from dragging/pulling forces in the transverse plane xy, thereby minimizing their wear and tear.

In the description and the claims in this application the words “comprise” and its variations such as “comprising” and “comprises” do not rule out the presence of other additional elements, components, or stages.

The discussion of documents, deeds, materials, apparatus, articles and the like is included in the text solely for the purpose of providing context for this invention; it should not however be understood that this material or part thereof constitutes general knowledge in the field relating to the invention prior to the priority date of each of the claims appended to this application.

1. An alkaline water electrolysis cell, comprising an anodic compartment, a cathodic compartment, and a separator (500, 550) placed in between the anodic compartment and the cathodic compartment; the anodic compartment, the separator (500, 550) and the cathodic compartment being placed sequentially along a longitudinal direction and the separator (500, 550) having its two major opposite surfaces oriented in a transverse plane substantially perpendicular to said longitudinal direction;
each of said two major opposite surfaces of the separator (500, 550) being provided with at least one anisotropic sealing gasket (100, 150, 125, 175), each of said anisotropic sealing gaskets (100, 150, 125, 175) being made of an anisotropic material and being characterized by a modulus |v| of the Poisson coefficient v between 0 and 0.3 in at least one direction of the transverse plane, when a force is applied to the anisotropic sealing gaskets (100, 150, 125, 175) in the longitudinal direction.

2. The cell according to claim 1, wherein said modulus |v| is between 0 and 0.2.

3. The cell according to claim 1, wherein the anisotropic sealing gaskets (100, 150, 125, 175) are made of: multidirectional expanded elastomers or expanded fluoropolymers.

4. The cell according to claim 3, wherein the anisotropic sealing gaskets (100, 150, 125, 175) are made of: multidirectional ePTFE, expanded EPDM or expanded chlorosulfonated polyethylene.

5. The cell according to claim 4, wherein the separator (500, 550) is a fabric made of plastic fibers.

6. The cell according to claim 4, wherein the separator (500, 550) is provided with a Zirconium-based coating.

7. The cell according to claim 4, wherein the separator (500, 550) is 50 μm to 500 μm thick.

8. The cell according to claim 1, wherein the anodic compartment comprises a current collector and an anode housed in a supporting frame (200), the cathodic compartment comprises a cathode (600) housed in a supporting frame (210) and an elastic element (300), wherein said anode and said cathode (600) are pressed against the separator (500) placed between them and provided with at least two gaskets (100, 150) and the anodic and cathodic compartments are in electrical connection with a first and a second current distributor (400, 450).

9. An alkaline water electrolyser comprising a plurality of cells stacked along the longitudinal direction and in mutual electrical and hydraulic connection with each other, wherein each cell of said plurality of cells is the cell according to claim 1.

10. The cell according to claim 1 wherein said modulus |v| is between 0 and 0.1.

11. The cell according to claim 10, wherein the separator (500, 550) is a fabric made of plastic fibers.

12. The cell according to claim 10, wherein the separator (500, 550) is provided with a Zirconium-based coating.

13. The cell according to claim 10, wherein the separator (500, 550) is 50 μm to 500 μm thick.

14. An alkaline water electrolyser comprising a plurality of cells stacked along the longitudinal direction and in mutual electrical and hydraulic connection with each other, wherein each cell of said plurality of cells is the cell according to claim 10.

15. The cell according to claim 1, wherein the separator (500, 550) is a fabric made of plastic fibers.

16. The cell according to claim 1, wherein the separator (500, 550) is provided with a Zirconium-based coating.

17. The cell according to claim 1, wherein the separator (500, 550) is 50 μm to 500 μm thick.

18. An alkaline water electrolyser comprising a plurality of cells stacked along the longitudinal direction and in mutual electrical and hydraulic connection with each other, wherein each cell of said plurality of cells is the cell according to claim 1.

19. An alkaline water electrolyser comprising a plurality of cells stacked along the longitudinal direction and in mutual electrical and hydraulic connection with each other, wherein each cell of said plurality of cells is the cell according to claim 4.
